(19) United States
(12) Patent Application Publication
(10) Pub. No.: US 2026/0343549 A1
(43) Pub. Date: Oct. 29, 2026

(54) METHODS AND DEVICES FOR UCI MULTIPLEXING FOR PUSCH AND PUCCH WITH REPETITIONS

(71) Applicant: ZTE Corporation, Shenzhen (CN)

(72) Inventors: Wei GOU, Shenzhen (CN); Xianghui HAN, Shenzhen (CN); Junfeng ZHANG, Shenzhen (CN); Shuaihua KOU, Shenzhen (CN)

(73) Assignee: ZTE Corporation, Shenzhen (CN)

(21) Appl. No.: 19/147,044

(22) PCT Filed: Jan. 12, 2023
(86) PCT No.: PCT/CN2023/071955

§ 371 Date: Jul. 10, 2025

(51) Int. Cl. H04W 72/21; H04W 72/0446

(52) U.S. Cl. CPC H04W 72/21; H04W 72/0446

(57) ABSTRACT

The present disclosure describes methods, system, and devices for uplink control information (UCI) multiplexing for physical uplink shared channel (PUSCH) and physical uplink control channel (PUCCH) with repetitions. One method includes executing, by a user equipment (UE), UCI multiplexing for at least one PUSCH transmission and a PUCCH transmission with repetitions, by: determining, by the UE, that at least one PUCCH repetition of the PUCCH transmission with repetitions overlaps with the at least one PUSCH transmission in a time domain; multiplexing, by the UE, UCI in the at least one PUCCH repetition on the at least one PUSCH transmission; and transmitting, by the UE, the UCI multiplexing on the at least one PUSCH transmission to a base station.

### TECHNICAL FIELD

The present disclosure is directed generally to wireless communications. Particularly, the present disclosure relates to methods and devices for uplink control information (UCI) multiplexing for physical uplink shared channel (PUSCH) and physical uplink control channel (PUCCH) with repetitions.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

In some existing wireless communication schemes, a physical uplink control channel (PUCCH) transmission with a certain repetition factor may be scheduled and transmitted; and one of the PUCCH transmission may overlaps with a physical uplink shared channel (PUSCH) transmission. In these communication schemes, there may be some issues/problems associated with uplink control information (UCI) multiplexing for the PUSCH transmission and the PUCCH transmission with repetitions. For example in some circumstances, the PUCCH transmission may be transmitted, and the PUSCH transmission, which overlaps with the PUCCH transmission in a slot, may not be transmitted, so that the PUSCH transmission is discarded

The present disclosure describes various embodiments for determining and/or executing UCI multiplexing for PUSCH transmission and PUCCH transmission with repetitions, addressing at least one of the issues/problems discussed above, improving performance of the wireless communication, particularly the performance of UCI multiplexing, PUCCH resource configuration, and/or PUCCH transmission.

### SUMMARY

This document relates to methods, systems, and devices for wireless communication, and more specifically, for uplink control information (UCI) multiplexing for physical uplink shared channel (PUSCH) and physical uplink control channel (PUCCH) with repetitions. The various embodiments in the present disclosure may increase the resource utilization efficiency, enhance coverage, and/or boost latency performance of the wireless communication.

In one embodiment, the present disclosure describes a method for wireless communication. The method includes executing, by a user equipment (UE), uplink control information (UCI) multiplexing for at least one physical uplink shared channel (PUSCH) transmission and a physical uplink control channel (PUCCH) transmission with repetitions, by: determining, by the UE, that at least one PUCCH repetition of the PUCCH transmission with repetitions overlaps with the at least one PUSCH transmission in a time domain; multiplexing, by the UE, UCI in the at least one PUCCH repetition on the at least one PUSCH transmission; and transmitting, by the UE, the UCI multiplexing on the at least one PUSCH transmission to a base station.

In one embodiment, the present disclosure describes a method for wireless communication. The method includes configuring, by a base station to a user equipment (UE), at least one physical uplink shared channel (PUSCH) transmission and a physical uplink control channel (PUCCH) transmission with repetitions, wherein the at least one PUCCH repetition of the PUCCH transmission with repetitions overlaps with the at least one PUSCH transmission in a time domain; and receiving, by the base station from the UE, UCI multiplexing on the at least one PUSCH transmission.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a schematic diagram of an exemplary embodiment for wireless communication.

FIG. 6 shows a schematic diagram of another exemplary embodiment for wireless communication.

FIG. 7 shows a schematic diagram of another exemplary embodiment for wireless communication.

FIG. 8 shows a schematic diagram of another exemplary embodiment for wireless communication.

FIG. 9 shows a schematic diagram of another exemplary embodiment for wireless communication.

FIG. 10 shows a schematic diagram of another exemplary embodiment for wireless communication.

FIG. 11 shows a schematic diagram of another exemplary embodiment for wireless communication.

FIG. 12 shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used.

Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for uplink control information (UCI) multiplexing for physical uplink shared channel (PUSCH) and physical uplink control channel (PUCCH) with repetitions.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

In some existing wireless communication schemes, PUCCH repetitions may be supported. One of the primary purposes of supporting PUCCH repetitions is to improve PUCCH reliability and coverage. The PUCCH repetition factor is generally configured or indicated as 2, 4 or 8. Therefore, after a PUCCH with repetitions is triggered, the PUCCH is repeatedly transmitted 2, 4 or 8 times according to the configured or indicated repetition factor.

In some implementations, for a PUCCH with repetition factor N, wherein N is a positive integer and larger than 1, the slot where the first PUCCH repetition is located is generally configured or indicated for a user equipment (UE) by a base station. In a time division duplex (TDD) cell, the slots of the remaining PUCCH repetitions may be determined based on the following rules. When a UL symbol or flexible symbol can be provided in a slot, and the UL symbol or flexible symbol is the same as the starting symbol configured for the PUCCH (for example, the symbol index in the slot is the same), and in the slot, starting from the uplink (UL) symbol or flexible symbol, consecutive UL symbols or flexible symbols can be provided, and the number of consecutive UL symbols or flexible symbols is greater than or equal to the number of symbols configured for the PUCCH, the slot is determined for the remaining PUCCH repetitions. In some implementations, in the determined slot, the same PUCCH resource as the PUCCH resource used by the first PUCCH repetition may be used as the remaining PUCCH repetitions.

In some implementations, wherein the PUCCH transmission with repetitions overlaps with the PUSCH transmission with or without repetitions in time domain in a slot, based on the existing specification, the PUCCH transmission is transmitted, but the PUSCH transmission is not transmitted. That is, the PUSCH transmission is discarded, which may lead to some issues/problems, for example, inefficient transmission. For another example, when UCI multiplexing is adopted, it may easily lead to unavailability of UCI joint decoding. For example in some implementations, when a UE transmits a PUCCH over a first number of slots and the UE transmits a PUSCH with repetition Type A or with transport block (TB) processing over multiple slots over a second number of slots, and the PUCCH transmission overlaps with the PUSCH transmission in one or more slots, and a set of certain conditions for multiplexing the UCI in the PUSCH are satisfied in the overlapping slots, the UE transmits the PUCCH and does not transmit the PUSCH in the overlapping slots. The first number of slots is larger than one slot. For example in some other implementations, when a UE transmits a PUCCH over a first number of slots and the UE transmits a PUSCH with repetition Type B over a second number of slots, and the PUCCH transmission overlaps with actual PUSCH repetitions in one or more slots, and a set of certain conditions for multiplexing the UCI in the PUSCH are satisfied for the overlapping actual PUSCH repetitions, the UE transmits the PUCCH and does not transmit the overlapping actual PUSCH repetitions.

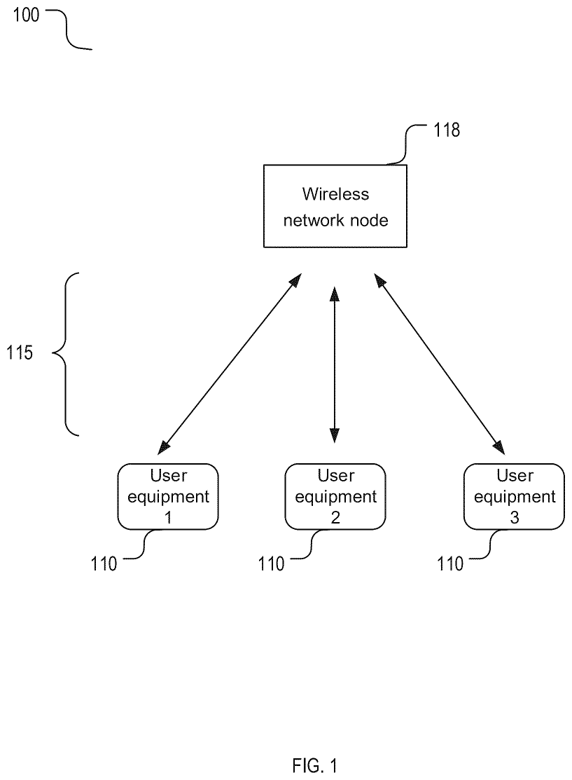

FIG. 1A shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

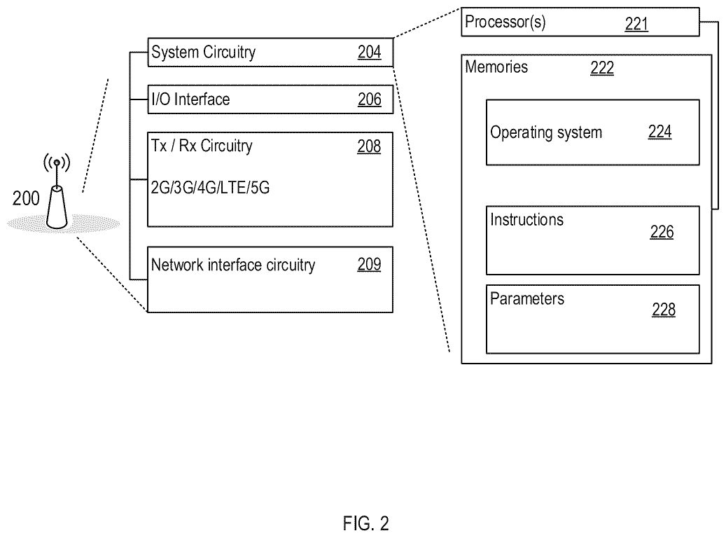

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

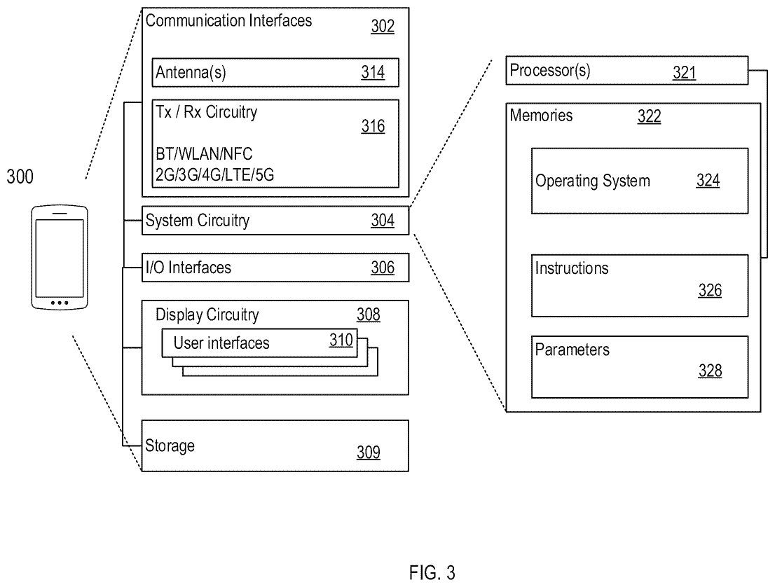

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for uplink control information (UCI) multiplexing for physical uplink shared channel (PUSCH) and physical uplink control channel (PUCCH) with repetitions, which may be implemented, partly or totally, on the network base station and/or the user equipment described above in FIGS. 2-3.

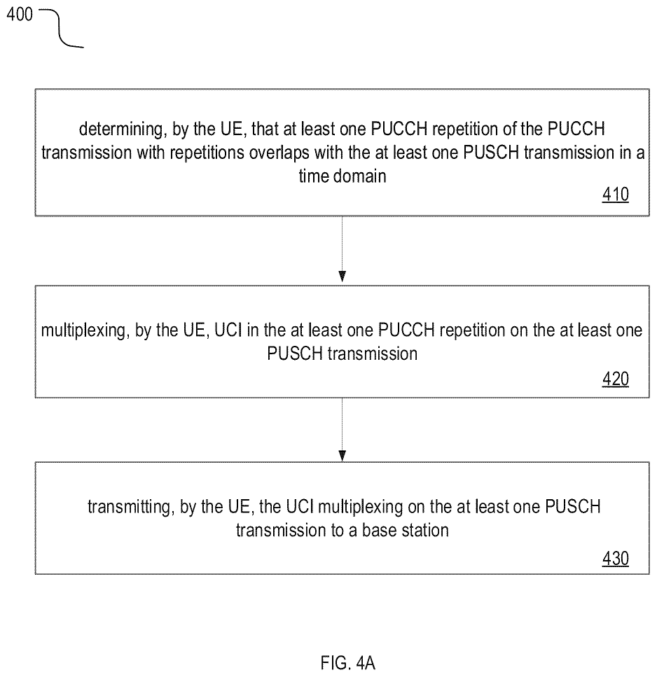

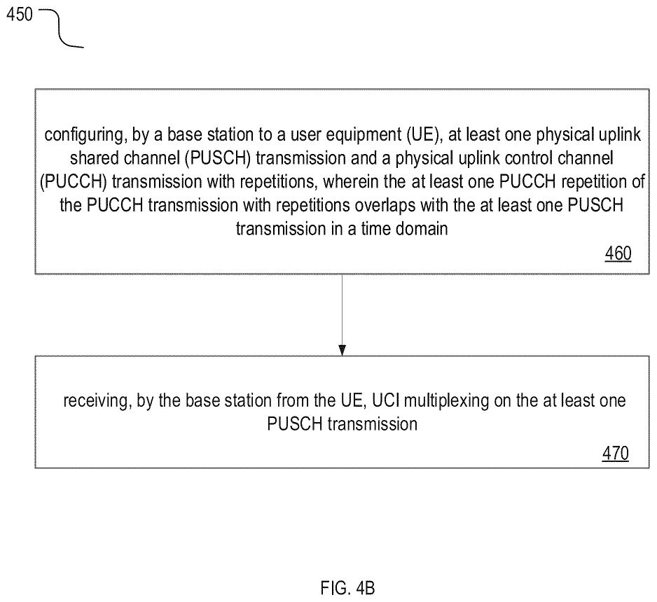

Referring to FIG. 4A, the present disclosure describes various embodiments of a method 400 for wireless communication including executing, by a user equipment (UE), uplink control information (UCI) multiplexing for at least one physical uplink shared channel (PUSCH) transmission and a physical uplink control channel (PUCCH) transmission with repetitions. The method 400 may include a portion or all of the following steps: step 410, determining, by the UE, that at least one PUCCH repetition of the PUCCH transmission with repetitions overlaps with the at least one PUSCH transmission in a time domain; step 420, multiplexing, by the UE, UCI in the at least one PUCCH repetition on the at least one PUSCH transmission; and/or step 430, transmitting, by the UE, the UCI multiplexing on the at least one PUSCH transmission to a base station. The UE may be referred as wireless communication device or wireless communication terminal.

Referring to FIG. 4B, the present disclosure describes various embodiments of a method 450 for wireless communication for uplink control information (UCI) multiplexing for physical uplink shared channel (PUSCH) and physical uplink control channel (PUCCH) with repetitions. The method 450 may include a portion or all of the following steps: step 460, configuring, by a base station to a user equipment (UE), at least one physical uplink shared channel (PUSCH) transmission and a physical uplink control channel (PUCCH) transmission with repetitions, wherein the at least one PUCCH repetition of the PUCCH transmission with repetitions overlaps with the at least one PUSCH transmission in a time domain; and/or step 470, receiving, by the base station from the UE, UCI multiplexing on the at least one PUSCH transmission. The base station may be referred as a wireless communication node.

In various implementations/embodiments in the present disclosure, “overlap in a time domain” may mean overlapping at least one symbol in a slot in the time domain.

In some implementations, in addition to a portion, an entire, or any combination of the described implementation(s)/embodiment(s), each PUCCH repetition of the PUCCH transmission with repetitions in each corresponding slot overlaps with a PUSCH transmission in the time domain; and/or in response to determining a condition being satisfied, the UE multiplexes UCI in the PUCCH repetition on the PUSCH transmission in the each corresponding slot and transmits the UCI multiplexing on the PUSCH transmission without transmitting the PUCCH repetition in the each corresponding slot to the base station.

In some implementations, in addition to a portion, an entire, or any combination of the described implementation(s)/embodiment(s), each PUCCH repetition of the PUCCH transmission with repetitions in each corresponding slot overlaps with a PUSCH repetition of a PUSCH transmission with repetitions in the time domain; and/or the UE multiplexes UCI in the PUCCH repetition on the PUSCH repetition in the each corresponding slot and transmits the UCI multiplexing on the PUSCH repetition without transmitting the PUCCH repetition in the each corresponding slot to the base station. The PUCCH transmission with repetitions and the PUSCH transmission with repetitions are located in same slots.

In some implementations, in addition to a portion, an entire, or any combination of the described implementation(s)/embodiment(s), each PUCCH repetition of the PUCCH transmission with repetitions in each corresponding slot overlaps with more than one PUSCH transmissions in the time domain, the more than one PUSCH transmissions comprises at least one of a PUSCH repetition of a PUSCH transmission with repetitions or a PUSCH transmission without repetitions; and/or for a first slot where a first PUCCH repetition is located, the UE multiplexes UCI in the first PUCCH repetition on a first PUSCH transmission in the first slot and transmits the UCI multiplexing on the first PUSCH transmission without transmitting the first PUCCH repetition in the first slot to the base station, wherein: the first PUSCH transmission is a first PUSCH repetition of a first PUSCH transmission with repetitions, and/or the first PUSCH transmission has an earliest start symbol among the more than one PUSCH transmission in the first slot, and/or PUCCH slots where the PUCCH repetitions of the PUCCH transmission with repetitions are located are a subset of PUSCH slots where the PUSCH repetitions of the first PUSCH transmission with repetitions are located; and/or for a slot where a PUCCH repetition, other than the first repetition, is located, the UE multiplexes UCI in the PUCCH repetition on a PUSCH repetition, other than the first PUSCH repetition, of the first PUSCH transmission with repetitions in the slot and transmits the UCI multiplexing on the PUSCH repetition without transmitting the PUCCH repetition in the first slot to the base station. In some implementations, the slots where the PUCCH repetitions of the PUCCH transmission with repetitions is located are included in the slots where the PUSCH repetitions of the first PUSCH transmission with repetitions is located. In some other implementations, the slots where the PUCCH repetitions of the PUCCH transmission with repetitions is located are a subset of the slots where the PUSCH repetitions of the first PUSCH transmission with repetitions is located.

In some implementations, in addition to a portion, an entire, or any combination of the described implementation(s)/embodiment(s), each PUCCH repetition of the PUCCH transmission with repetitions in each corresponding slot overlaps with a PUSCH repetition of a PUSCH transmission with repetitions in the time domain; and/or the UE multiplexes UCI in the PUCCH repetition on the PUSCH repetition of the PUSCH transmission with repetitions in the each corresponding slot and transmits the UCI multiplexing on the PUSCH repetition of the PUSCH transmission with repetitions without transmitting the PUCCH repetition in the each corresponding slot to the base station.

In some implementations, in addition to a portion, an entire, or any combination of the described implementation(s)/embodiment(s), the PUCCH transmission with repetitions and the PUSCH transmission with repetitions have a same starting slot; and/or PUCCH slots where the PUCCH repetitions of the PUCCH transmission with repetitions are located are a subset of PUSCH slots where the PUSCH repetitions of the PUSCH transmission with repetitions are located, and in one or more slots where the PUCCH transmission and the PUSCH transmission are both in, the PUCCH transmission and the PUSCH transmission overlap each other in the time domain; and/or for at least one remaining PUSCH repetition of the PUSCH transmission that does not overlap with any PUCCH transmission: the UE multiplexes UCI in the PUCCH repetition on the at least one remaining PUSCH repetition and transmits the UCI multiplexing on the at least one remaining PUSCH repetition to the base station, and/or the UE directly transmits the at least one remaining PUSCH repetition without transmitting the UCI multiplexing on the at least one remaining PUSCH repetition to the base station.

In some implementations, in addition to a portion, an entire, or any combination of the described implementation(s)/embodiment(s), the PUCCH transmission with repetitions and the PUSCH transmission with repetitions have a same starting slot; and/or the repetition factor of the PUCCH transmission with repetitions is less than or equal to the repetition factor of the PUSCH transmission with repetitions; and/or and in one or more slots where the PUCCH transmission and the PUSCH transmission are both in, the PUCCH transmission and the PUSCH transmission overlap each other in the time domain: the UE multiplexes UCI in the PUCCH repetition on the at least one remaining PUSCH repetition and transmits the UCI multiplexing on the at least one remaining PUSCH repetition to the base station, and/or the UE directly transmits the at least one remaining PUSCH repetition without transmitting the UCI multiplexing on the at least one remaining PUSCH repetition to the base station.

In some implementations, in addition to a portion, an entire, or any combination of the described implementation(s)/embodiment(s), the PUCCH transmission with repetitions and the PUSCH transmission with repetitions have different starting slots; and/or PUCCH slots where the PUCCH repetitions of the PUCCH transmission with repetitions are located are a subset of PUSCH slots where the PUSCH repetitions of the first PUSCH transmission with repetitions are located; and/or for at least one remaining PUSCH repetition of the PUSCH transmission that does not overlap with any PUCCH transmission: the UE multiplexes UCI in the PUCCH repetition on the at least one remaining PUSCH repetition and transmits the UCI multiplexing on the at least one remaining PUSCH repetition to the base station, and/or the UE directly transmits the at least one remaining PUSCH repetition without transmitting the UCI multiplexing on the at least one remaining PUSCH repetition to the base station.

In some implementations, in addition to a portion, an entire, or any combination of the described implementation(s)/embodiment(s), each PUCCH repetition of multiple PUCCH transmissions with repetitions in each corresponding slot overlaps with a PUSCH repetition of a PUSCH transmission with repetitions in the time domain; and/or the UE multiplexes each UCI in the PUCCH repetition of the multiple PUCCH transmissions with repetitions on the overlapping PUSCH repetition in the each corresponding slot and transmits the UCI multiplexing on the overlapping PUSCH repetition without transmitting the PUCCH repetition in the each corresponding slot to the base station.

In some implementations, in addition to a portion, an entire, or any combination of the described implementation(s)/embodiment(s), each PUCCH repetition of multiple PUCCH transmissions with repetitions in each corresponding slot overlaps with a PUSCH repetition of a PUSCH transmission with repetitions in the time domain; and/or for slots where PUCCH repetitions of a first PUCCH transmission with repetitions having earliest starting slot are located, the UE multiplexes each UCI in the PUCCH repetitions of the first PUCCH transmission with repetitions on the overlapping PUSCH repetition in the each corresponding slot and transmits the UCI multiplexing on the overlapping PUSCH repetition without transmitting the PUCCH repetition to the base station; and/or for other slots where PUCCH repetitions, other than the first PUCCH transmission with repetitions having earliest starting slot, are located, the UE directly transmits the overlapping PUSCH repetition without the UCI multiplexing in each corresponding slot to the base station.

In some implementations, in addition to a portion, an entire, or any combination of the described implementation(s)/embodiment(s), each PUCCH repetition of the PUCCH transmission with repetitions in each corresponding slot overlaps with a PUSCH transmission of multiple PUSCH transmissions in the time domain, the multiple PUSCH transmissions comprises at least one of a PUSCH transmission with repetitions or a PUSCH transmission without repetitions; and/or in response to determining a condition being satisfied, the UE multiplexes UCI in the PUCCH repetition on each overlapping PUSCH transmission in the each corresponding slot and transmits the UCI multiplexing on the PUSCH transmission without transmitting the PUCCH repetition in the each corresponding slot to the base station.

In some implementations, in addition to a portion, an entire, or any combination of the described implementation(s)/embodiment(s), the condition comprises at least one of the following: the multiple PUSCH transmissions having a same modulation mode, and/or the multiple PUSCH transmissions having a same uplink (UL) downlink assignment index (DAI), and/or the multiple PUSCH transmissions having a same beta-offset.

In some implementations, in addition to a portion, an entire, or any combination of the described implementation(s)/embodiment(s), the multiple PUSCH transmissions comprises a plurality of PUSCH transmissions with repetitions.

In some implementations, in addition to a portion, an entire, or any combination of the described implementation(s)/embodiment(s), the multiple PUSCH transmissions comprises at least one PUSCH transmission and at least one PUSCH transmission without repetitions.

In some implementations, in addition to a portion, an entire, or any combination of the described implementation(s)/embodiment(s), each PUCCH repetition of a portion of the PUCCH transmission with repetitions in each corresponding slot overlaps with a PUSCH transmission of multiple PUSCH transmissions in the time domain, the multiple PUSCH transmissions comprises at least one of a PUSCH transmission with repetitions or a PUSCH transmission without repetitions; and/or in response to determining a condition being satisfied: for slots where PUCCH repetitions overlapping the PUSCH transmissions are located, the UE multiplexes each UCI in the PUCCH repetitions overlapping the PUSCH transmissions on the overlapping PUSCH repetition in the each corresponding slot and transmits the UCI multiplexing on the overlapping PUSCH repetition without transmitting the PUCCH repetition to the base station, and/or for other slots where PUCCH repetitions without any overlapping PUSCH transmission are located, the UE directly transmits the PUSCH repetitions without any overlapping PUSCH transmission in each corresponding slot to the base station.

In some implementations, in addition to a portion, an entire, or any combination of the described implementation(s)/embodiment(s), the condition comprises at least one of the following: the UCI in the PUCCH transmission with repetitions comprising at least three bits; and/or the UCI in the PUCCH transmission with repetitions being a single UCI type; and/or the PUCCH transmission with repetitions and the multiple PUSCH transmissions having a same modulation mode, and/or a resource size used by the UCI in the PUCCH transmission with repetitions being same as that used by UCI in the multiple PUSCH transmissions.

In some implementations, in addition to a portion, an entire, or any combination of the described implementation(s)/embodiment(s), the multiple PUSCH transmissions comprises a plurality of PUSCH transmissions with repetitions.

In some implementations, in addition to a portion, an entire, or any combination of the described implementation(s)/embodiment(s), the multiple PUSCH transmissions comprises at least one PUSCH transmission and at least one PUSCH transmission without repetitions.

Various embodiments will be described below as non-limiting examples for uplink control information (UCI) multiplexing for physical uplink shared channel (PUSCH) and physical uplink control channel (PUCCH) with repetitions.

### Embodiment Set I

The present disclosure describes various embodiments, wherein for a PUCCH transmission with a repetition factor of N (N>1), when all the N PUCCH repetitions overlap with the PUSCH transmission or PUSCH repetitions respectively in the time domain in the slots where the PUCCH repetitions are located, the UCI in the PUCCH repetitions is multiplexed in the PUSCH transmission overlapping with the PUCCH repetitions. The PUCCH repetition may not be transmitted. That is, the UCIs in the PUCCH transmission are respectively multiplexed in the PUSCH transmission overlapped with the PUCCH transmission, and the PUCCH transmission is not transmitted.

For a first set of circumstances, in some implementations, when a PUCCH transmission and a PUSCH transmission have the same repetition factor and the same slots, and the PUCCH repetition of the PUCCH transmission and the PUSCH repetition of the PUSCH transmission overlap respectively in the slots in the time domain, UCI multiplexing is performed for the PUCCH transmission and the PUSCH transmission. The detailed operation is that the UCI multiplexing is performed respectively for the PUCCH repetition of the PUCCH transmission and the PUSCH repetition of the PUSCH transmission in each slot where they overlap. After the UCI multiplexing is performed, the PUCCH repetitions are not transmitted in their overlapping slots, and the PUSCH repetitions are transmitted, and the UCI is transmitted in the PUSCH repetition.

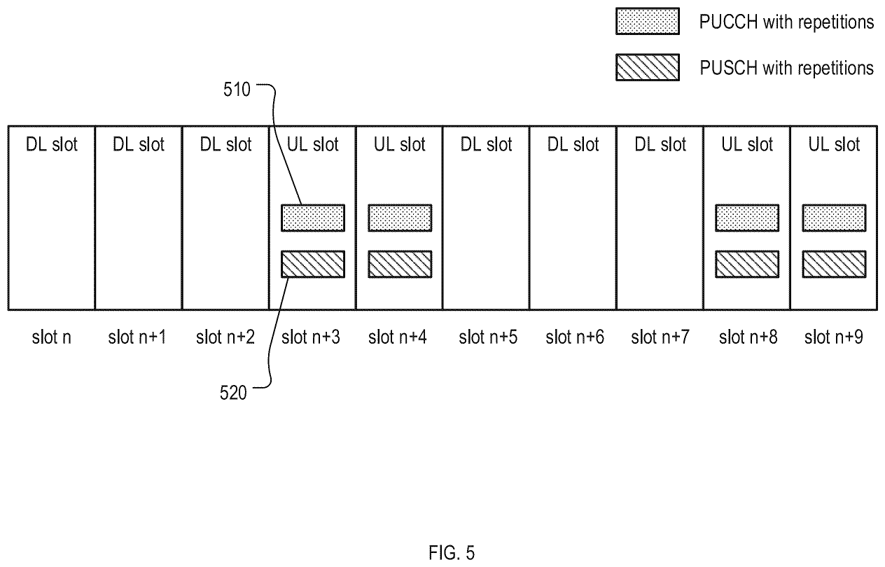

For a non-limiting example, as shown in FIG. 5, a PUCCH transmission with a repetition factor of 4 is determined to start in slot n+3, wherein a first PUCCH repetition 510 is in slot n+3. According to the existing mechanism, slot n+4, slot n+8, and slot n+9 are determined for the remaining repetitions of the PUCCH transmission. In the determined slots, the same PUCCH resource is used for different repetitions of the PUCCH transmission. A PUSCH transmission with a repetition factor of 4 is determined to start in slot n+3, wherein a first PUSCH repetition 520 is in slot n+3 According to the existing mechanism, slot n+4, slot n+8, and slot n+9 are determined for the remaining repetitions of the PUSCH transmission. In the determined slots, the same PUSCH resource is used for different repetitions of the PUSCH transmission.

In various embodiments/implementations in the present disclosure, a “first” repetition of a PUCCH/PUSCH transmission with repetitions may refer to a “starting” repetition or an “earliest” repetition in the PUCCH/PUSCH transmission with repetitions.

The PUCCH transmission may overlap with the PUSCH transmission in the time domain in each determined slot. That is, each repetition of the PUCCH transmission overlaps with a PUSCH repetition of the PUSCH transmission in the time domain in the corresponding slot. The “overlap” may refer to an entire overlap wherein each repetition of the PUCCH transmission overlaps with a PUSCH repetition of the PUSCH transmission in the time domain on all symbols of either repetition in the corresponding slot; or may refer to a partial overlap wherein each repetition of the PUCCH transmission overlaps with a PUSCH repetition of the PUSCH transmission in the time domain on at least one symbol in the corresponding slot.

Referring to FIG. 5, the UCI in the PUCCH transmission is multiplexed in the PUCCH transmission. For example, the UCI in a PUCCH repetition of the PUCCH transmission is multiplexed in the repetition of the PUSCH transmission that overlaps with the PUCCH repetition. That is, when the first PUCCH repetition of the PUCCH transmission overlaps with the first PUSCH repetition of the PUSCH transmission in the slot n+3, the UCI in the first PUCCH repetition is multiplexed in the first PUSCH repetition. The second PUCCH repetition of the PUCCH transmission overlaps with the second PUSCH repetition of the PUSCH transmission in the slot n+4, then the UCI in the second PUCCH repetition is multiplexed in the second PUSCH repetition. The third PUCCH repetition of the PUCCH transmission overlaps with the third PUSCH repetition of the PUSCH transmission in the slot n+8, then the UCI in the third PUCCH repetition is multiplexed in the third PUSCH repetition. The fourth PUCCH repetition of the PUCCH transmission overlaps with the fourth PUSCH repetition of the PUSCH transmission in the slot n+9, then the UCI in the fourth PUCCH repetition is multiplexed in the fourth PUSCH repetition. In some implementations, all repetitions of the PUCCH transmission are not transmitted. All repetitions of the PUSCH transmission are transmitted. In some implementations, the UCI in each repetition of the PUCCH transmission is the same.

In various embodiments/implementations in the present disclosure, a “first” PUCCH/PUSCH repetition may refer to an “earliest” PUCCH/PUSCH repetition, for example the PUCCH/PUSCH repetition in slot n+3 in FIG. 5. A “second” PUCCH/PUSCH repetition may refer to a “second earliest” PUCCH/PUSCH repetition, for example the PUCCH/PUSCH repetition in slot n+4 in FIG. 5. A “third” PUCCH/PUSCH repetition may refer to a “third earliest” PUCCH/PUSCH repetition, for example the PUCCH/PUSCH repetition in slot n+8 in FIG. 5. A “fourth” PUCCH/PUSCH repetition may refer to a “fourth earliest” PUCCH/PUSCH repetition, for example the PUCCH/PUSCH repetition in slot n+9 in FIG. 5.

In some implementations, the slots corresponding to all repetitions of a PUCCH transmission or a PUSCH transmission with repetitions are determined as shown in FIG. 5.

In some implementations, when a PUCCH transmission without repetitions overlaps with multiple PUSCHs without repetitions in a slot in the time domain, the UCI in the PUCCH transmission is multiplexed in the PUSCH transmission with the earliest start symbol.

In some implementations, when a PUCCH transmission with repetitions overlaps with multiple PUSCH transmissions in a slot in the time domain, the following may be used to determine which PUSCH transmission the UCI in the PUCCH transmission should be multiplexed in, wherein the multiple PUSCH transmissions include PUSCH repetitions and PUSCH transmissions without repetitions.

When the slot is the slot where the first PUCCH repetition of the PUCCH transmission is located, that is, the first PUCCH repetition overlaps with multiple PUCCH transmissions in a slot in the time domain, the following applies: when the repetition factor of a PUSCH transmission is greater than or equal to the repetition factor of the PUCCH transmission, which may mean that the slots of a PUCCH transmission with repetitions are a subset of the slots of the PUSCH transmission with repetitions, and the PUSCH transmission has the earliest start symbol in the slot and is the initial PUSCH transmission, the PUSCH transmission is selected. When there are multiple PUSCH transmissions that meet the above conditions, any one PUSCH transmission is selected from the multiple PUSCH transmissions that meet the conditions. Here, for a PUSCH transmission with repetitions, the PUSCH transmission is the initial PUSCH transmission, which refers to the first PUSCH repetition. For a PUSCH transmission without repetitions, the PUSCH transmission is the initial PUSCH transmission, which refers to the PUSCH transmission itself.

When the slot is the slot where the PUCCH repetition other than the first PUCCH repetition is located, the following applies: selecting the PUSCH transmission multiplexed with the first PUCCH repetition, even when the PUSCH transmission does not have the earliest start symbol in the slot.

For the first set of circumstances, the UCIs in all repetitions of the PUCCH transmission are respectively multiplexed in different repetitions of the same PUSCH transmission. Because these PUSCH repetitions correspond to the same PUSCH transmission, they use the same PUSCH resources, the same modulation and the same beta-offset. In this way, the UCIs multiplexed in these PUSCH repetitions can obtain the same resources and the same modulation respectively. Therefore, these UCIs multiplexed in these PUSCH repetitions may still be jointly demodulated and decoded to obtain gain.

For a second set of circumstances, when all the repetitions of a PUCCH transmission with repetitions overlap with all or part of the repetitions of a PUSCH transmission with repetitions respectively in the time domain in one or more slots, the UCI in the PUCCH transmission is multiplexed in the PUSCH transmission in one or more slots where they overlap in the time domain. The second set of circumstances may include the following subsets of circumstances.

For a first subset of circumstances, when a PUCCH transmission with repetitions and a PUSCH transmission with repetitions have the same start slot, and optionally the number of repetitions of PUCCH transmission is less than the number of repetitions of PUSCH transmission, which may mean that the slots of a PUCCH transmission with repetitions are a subset of the slots of the PUSCH transmission with repetitions, and in each slot where the PUCCH repetitions are located, the repetition of the PUCCH transmission overlaps with the repetition of the PUSCH transmission respectively in the time domain, the UCI in the PUCCH transmission is multiplexed in the PUSCH transmission in one or more slots where they overlap in the time domain.

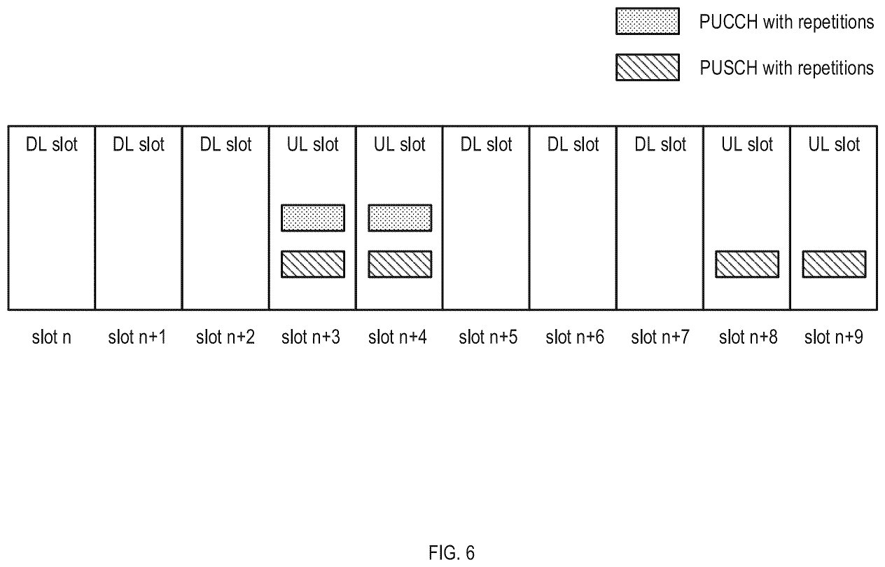

For a non-limiting example as shown in FIG. 6, a PUCCH transmission with repetitions has the same starting slot n+3 as a PUSCH transmission with repetitions, and the repetition factor 2 of the PUCCH transmission is less than the repetition factor 4 of the PUSCH transmission, and each repetition of the PUCCH transmission overlaps with one repetition of the PUSCH transmission respectively in slot n+3 and slot n+4 in the time domain, then the UCI in the PUCCH transmission is multiplexed in repetitions of the PUSCH transmission respectively in slot n+3 and slot n+4. In this way, the PUCCH repetitions are not transmitted in slot n+3 and slot n+4.

In some implementations, since the number of repetitions of the PUCCH transmission is less than the number of repetitions of the PUSCH transmission, the following operation may be used to determine how the remaining repetitions of the PUSCH transmission should be handled, such as those in slot n+8 and slot n+9. The operation is as the following. The UCI in the PUCCH transmission continues to be multiplexed in the remaining PUSCH repetitions, that is, the UCI is also multiplexed in the repetitions of the PUSCH transmission in slot n+8 and slot n+9, respectively. In this way, the UCI is actually transmitted 4 times. Alternatively, the remaining PUSCH repetitions of the PUSCH transmission are directly transmitted in slot n+8 and slot n+9, that is, the UCI is not multiplexed in the remaining PUSCH repetitions. In this way, the UCI is actually transmitted twice.

For a second subset of circumstances, when a PUCCH transmission with repetitions and a PUSCH transmission with repetitions have different start slots, and optionally, the number of repetitions of the PUCCH transmission is less than the number of repetitions of the PUSCH transmission, which may mean that the slots of a PUCCH transmission with repetitions are a subset of the slots of the PUSCH transmission with repetitions, and the PUCCH repetition overlaps with one of the repetitions of the PUSCH transmission in the time domain in each slot where the repetitions of the PUCCH transmission are located, then the UCI in the PUCCH transmission is multiplexed in the PUSCH transmission in one or more slots where they overlap in the time domain.

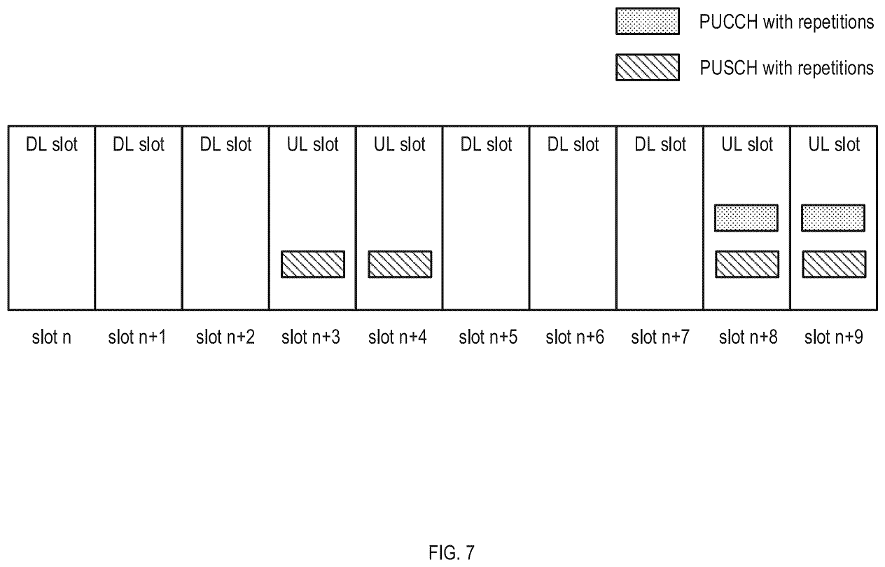

For another non-limiting example as shown in FIG. 7, a PUCCH transmission with a repetition factor of 2 starts in slot n+8. A PUSCH transmission with a repetition factor of 4 also starts in slot n+3 and the repetition factor of the PUCCH transmission is less than that of PUSCH transmission. The first PUCCH repetition and second PUCCH repetition of the PUCCH transmission are in slot n+8 and slot n+9, respectively. The first PUCCH repetition overlaps with one PUSCH repetition of the PUSCH transmission in the time domain. The second PUCCH repetition overlaps with another one PUSCH repetition of the PUSCH transmission in the time domain. Therefore, the UCI in the PUCCH transmission is respectively multiplexed in the PUSCH transmission in slot n+8 and slot n+9. That is, the UCI in the first PUCCH repetition is multiplexed in the one PUSCH repetition of the PUSCH transmission in slot n+8. The UCI in the second PUCCH repetition is multiplexed in the another one PUSCH repetition of the PUSCH transmission in slot n+9. In this way, the first PUCCH repetition and second PUCCH repetition are not transmitted in slot n+8 and slot n+9. The PUSCH repetitions of the PUSCH transmission are not transmitted in slot n+8 and slot n+9.

In some implementations, since the number of repetitions of the PUCCH transmission is less than the number of repetitions of the PUSCH transmission, the following operations may be used to determine how the remaining repetitions of the PUSCH transmission should be handled, such as those in slot n+3 and slot n+4. The operation is as the following. The UCI in the PUCCH transmission is respectively multiplexed in the first and second PUSCH repetitions, that is, the UCI is also multiplexed in the repetitions of the PUSCH transmission in slot n+3 and slot n+4, respectively. In this way, the UCI is actually transmitted 4 times. Alternatively, the first and second PUSCH repetitions of the PUSCH transmission are directly transmitted in slot n+3 and slot n+4, that is, the UCI is not multiplexed in the first and second PUSCH repetitions. In this way, the UCI is actually transmitted twice.

For a third subset of circumstances, when multiple PUCCH transmissions with repetitions overlap with one PUSCH transmission with repetitions in the time domain, and optionally, the number of PUCCH transmission repetitions is less than the number of PUSCH transmission repetitions, which may mean that the slots of multiple PUCCH transmission with repetitions are a subset of the slots of the PUSCH transmission with repetitions, and in each slot where the each PUCCH repetition of the multiple PUCCH transmissions is located, each PUCCH repetition overlaps with one repetition of the PUSCH transmission in the time domain, then the UCI in each PUCCH repetition is respectively multiplexed in the one repetition of the PUSCH transmission overlapped with the PUCCH repetition in their overlapping slot; Or, then the UCI in the PUCCH transmission with the earliest start slot among the multiple PUCCH transmissions is multiplexed in the one repetition of the PUSCH transmission overlapped with the PUCCH repetition of the PUCCH transmission in overlapping slots, and the remaining PUCCH transmissions are not transmitted, and the UCI in them is not multiplexed in the PUSCH transmission.

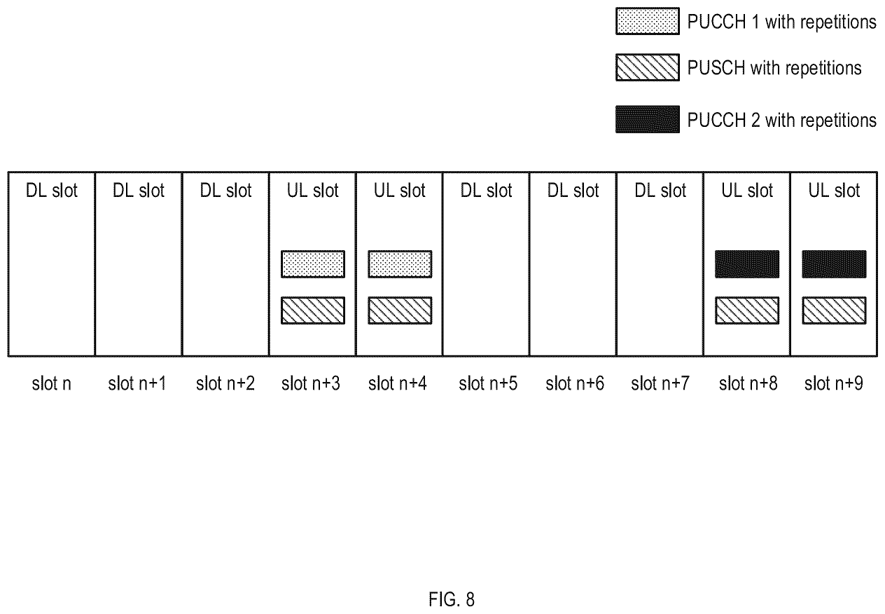

For another non-limiting example as shown in FIG. 8, a first PUCCH (PUCCH1) transmission with repetition factor 2 starts from slot n+3. A second PUCCH (PUCCH2) transmission with repetition factor 2 starts from slot n+8. A PUSCH transmission with a repetition factor of 4 starts from slot n+3, wherein the repetition factor of PUCCH transmission is 2 less than the repetition factor of PUSCH transmission 4. The PUCCH1 repetitions overlap with the two repetitions of the PUSCH transmission respectively in the time domain in slot n+3 and slot n+4 where PUCCH1 repetitions are located. The PUCCH2 repetitions also overlap with the other two repetitions of the PUSCH transmission in the time domain in slot n+8 and slot n+9 where PUCCH2 repetitions are located. In this way, the UCI in the PUCCH1 transmission is multiplexed in the two repetitions of the PUSCH transmission in slot n+3 and slot n+4 respectively. The UCI in the PUCCH2 transmission is multiplexed in the other two repetitions of the PUSCH transmission in slot n+8 and slot n+9 respectively. In this way, PUCCH1 transmission is not transmitted in slot n+3 and slot n+4. PUCCH2 transmission is not transmitted in slot n+8 and slot n+9.

In some implementations, different repetitions of a PUSCH transmission are multiplexed with UCIs in different PUCCH transmissions. When these UCIs are HARQ-ACK information, the UL downlink assignment index (DAI) value in the UL grant corresponding to the PUSCH transmission is equal to the maximum number of HARQ-ACK bits in different HARQ-ACK information. These different HARQ-ACK information are multiplexed in different repetitions of the PUSCH transmission based on the UL DAI value.

In some implementations, since the start slot of the PUCCH1 transmission is earlier than the start slot of the PUCCH2 transmission, the UCI in the PUCCH2 transmission is not multiplexed in the PUSCH transmission and the PUCCH2 transmission is not transmitted. The UCI in the PUCCH1 transmission is multiplexed in the repetition of the PUSCH transmission in slot n+3 and slot n+4 respectively. PUCCH1 transmission is not transmitted in slot n+3 and slot n+4. In some implementations, the UCI multiplexing may not be optimal, and still works.

For a fourth subset of circumstances, when a PUCCH transmission with repetitions overlaps with multiple PUSCH transmissions with or without repetitions in the time domain, and optionally, the number of repetitions of the PUCCH transmission is greater than the number of repetitions of each PUSCH transmission, which may mean that the slots of multiple PUSCH transmission with repetitions are a subset of the slots of the PUCCH transmission with repetitions, and in the slot where each PUCCH repetition of the PUCCH transmission is located, the each PUCCH repetition overlaps with one PUSCH transmission without repetitions or one PUSCH repetition corresponds to the multiple PUSCH transmissions in the time domain, then the UCI in each repetition of the PUCCH transmission is respectively multiplexed in the one PUSCH transmission without repetitions or the one PUSCH repetition overlapped with the each repetition of the PUCCH transmission. In some implementations, the PUCCH transmission is not transmitted.

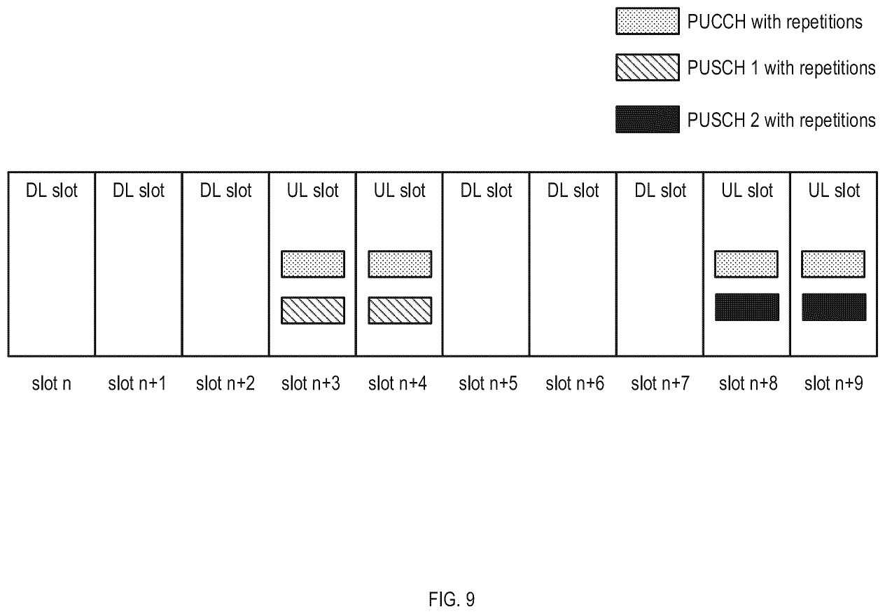

For another non-limiting example as shown in FIG. 9, a PUCCH transmission with a repetition factor of 4 starts from slot n+3, and its repetitions are respectively in slot n+3, slot n+4, slot n+8, and slot n+9. PUSCHI transmission with repetition factor 2 starts from slot n+3, and its repetition is in slot n+3 and slot n+4. PUSCH2 transmission with repetition factor 2 starts from slot n+8, and its repetition is in slot n+8 and slot n+9. In each slot where each repetition of the PUCCH transmission is located, each repetition of the PUCCH transmission overlaps with one repetition of the PUSCH1 transmission or one repetition of the PUSCH2 transmission respectively in the time domain. That is, each repetition of the PUCCH transmission overlaps with a PUSCH transmission in the time domain. Therefore, the UCI in the PUCCH transmission is respectively multiplexed in the PUSCH transmission overlapped with the PUCCH transmission in each overlapped slot. That is, in slot n+3 and slot n+4, the UCI in the PUCCH transmission is respectively multiplexed in two PUSCH1 repetitions of the PUSCH1 transmission. In slot n+8 and slot n+9, the UCI in the PUCCH transmission is respectively multiplexed in two PUSCH2 repetitions of the PUSCH2 transmission. The PUCCH transmission is not transmitted in slot n+3, slot n+4, slot n+8 and slot n+9.

In some implementations, when the UCI in a PUCCH transmission with repetitions is respectively multiplexed in different PUSCH transmissions, these different PUSCH transmissions should meet at least one of the following conditions in order to better joint decoding between UCIs multiplexed in these different PUSCH transmissions. The conditions include: the same modulation mode, the same UL DAI value, and/or the same beta-offset for same UCI type.

In some implementations, when the UCI in a PUCCH transmission with repetitions is respectively multiplexed in different PUSCH transmissions, these different PUSCH transmissions should meet at least two of the following conditions in order to better joint decoding between UCIs multiplexed in these different PUSCH transmissions. The conditions include: the same modulation mode, the same UL DAI value, and/or the same beta-offset for same UCI type.

In some implementations, when the UCI in a PUCCH transmission with repetitions is respectively multiplexed in different PUSCH transmissions, these different PUSCH transmissions should meet all of the following conditions in order to better joint decoding between UCIs multiplexed in these different PUSCH transmissions. The conditions include: the same modulation mode, the same UL DAI value, and the same beta-offset for same UCI type.

In various implementations, the modulation, UL DAI, and/or beta-offset may be indicated in UL grants corresponding to these PUSCH transmissions.

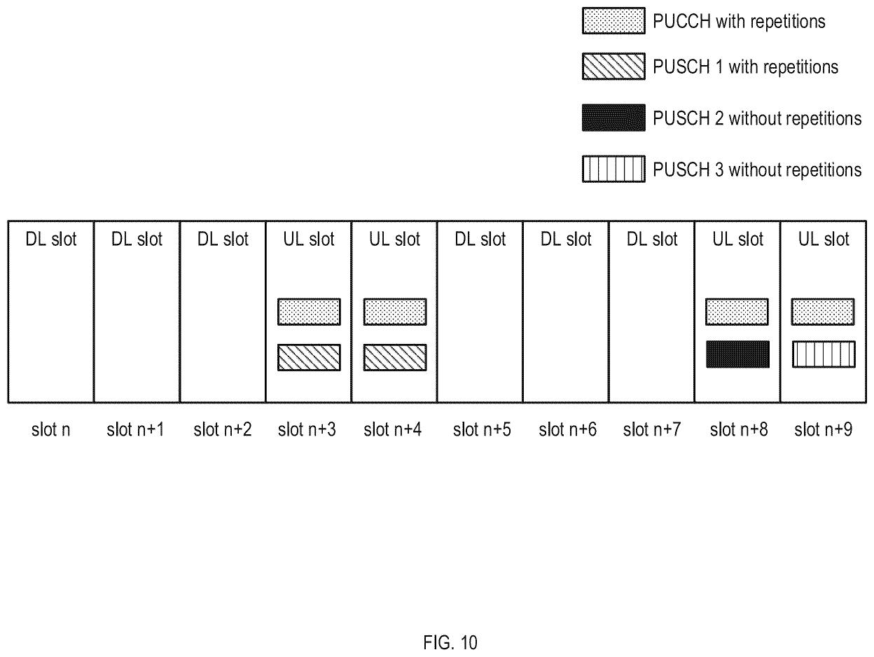

For another non-limiting example as shown in FIG. 10, a PUCCH transmission with a repetition factor of 4 starts from slot n+3, and its repetitions are respectively in slot n+3, slot n+4, slot n+8, and slot n+9. PUSCH1 transmission with repetition factor 2 starts from slot n+3, and its repetition is in slot n+3 and slot n+4. PUSCH2 transmission without repetition factor in slot n+8. PUSCH3 transmission without repetition factor in slot n+9. In each slot where each repetition of the PUCCH transmission is located, each repetition of the PUCCH transmission overlaps with one repetition of the PUSCH1 transmission or the PUSCH2 transmission or the PUSCH3 transmission respectively in the time domain. That is, each repetition of the PUCCH transmission overlaps with a PUSCH transmission in the time domain. Therefore, the UCI in the PUCCH transmission is respectively multiplexed in the PUSCH transmission overlapped with the PUCCH transmission in each overlapped slot.

That is, in slot n+3 and slot n+4, the UCI in the PUCCH transmission is respectively multiplexed in two PUSCH1 repetitions of the PUSCH1 transmission. In slot n+8, the UCI in the PUCCH transmission is multiplexed in the PUSCH2 transmission. In slot n+9, the UCI in the PUCCH transmission is multiplexed in the PUSCH3 transmission. The PUCCH transmission is not transmitted in slot n+3, slot n+4, slot n+8, and slot n+9.

In some implementations, when the UCI in a PUCCH transmission with repetitions is respectively multiplexed in different PUSCH transmissions, these different PUSCH transmissions should meet at least one of the following conditions in order to better joint decoding between UCIs multiplexed in these different PUSCH transmissions. The conditions include: the same modulation, the same UL DAI value, and/or the same beta-offset for same UCI type.

In some implementations, when the UCI in a PUCCH transmission with repetitions is respectively multiplexed in different PUSCH transmissions, these different PUSCH transmissions should meet at least two of the following conditions in order to better joint decoding between UCIs multiplexed in these different PUSCH transmissions. The conditions include: the same modulation, the same UL DAI value, and/or the same beta-offset for same UCI type.

In some implementations, when the UCI in a PUCCH transmission with repetitions is respectively multiplexed in different PUSCH transmissions, these different PUSCH transmissions should meet all of the following conditions in order to better joint decoding between UCIs multiplexed in these different PUSCH transmissions. The conditions include: the same modulation, the same UL DAI value, and the same beta-offset for same UCI type.

In various implementations, the modulation, UL DAI and beta-offset may be indicated in UL grants corresponding to these PUSCH transmissions.

Various embodiments may provide conditions for executing UCI multiplexing in various circumstances. When the conditions as described in various embodiments/implementations are met, UCI multiplexing is executed, and joint decoding may still be performed between different UCI transmissions.

In some implementations, a PUCCH transmission with repetitions overlaps PUSCH transmission in the time domain, and the conditions may include the following. Each repetition of the PUCCH transmission overlaps with the PUSCH transmission in the time domain. It includes: multiple PUCCH repetitions of the PUCCH transmission overlap with different repetitions of the same PUSCH transmission in the time domain respectively. It also includes that each PUCCH repetition of the PUCCH transmission overlaps with different PUSCH transmissions in the time domain respectively. It also includes a combination of the above two situations. If the repetitions of the PUCCH transmission overlap with multiple PUSCH transmissions in the time domain, the multiple PUSCH transmissions are required to meet at least one of the following conditions: the same modulation, the same UL DAI value, and the same beta-offset value.

### Embodiment Set II

The present disclosure describes various embodiments, wherein the partial repetitions of a PUCCH transmission with repetitions overlap with one or more PUSCH transmissions with or without repetition factors in the time domain, and the remaining repetitions of the PUCCH transmission do not overlap with any PUSCH transmission in the time domain. In some implementations, when the following conditions are met, the UCI in the PUCCH transmission is multiplexed on the PUSCH transmission in the slots where the PUCCH transmission overlaps the PUSCH transmission. The partial repetitions of the PUCCH transmission are not transmitted. The remaining repetitions of the PUCCH transmission are still transmitted.

In some implementations, a PUSCH transmission without repetition factor means that the PUSCH transmission does not perform repeated transmission; and a PUSCH transmission with repetition factor means that the PUSCH transmission performs repeated transmission.

In some implementations, when a PUCCH transmission with repetition and a PUSCH transmission meet the following conditions, the UCI in the PUCCH transmission is multiplexed on the PUSCH in overlapping slots. A PUCCH transmission with repetitions overlaps with one or more PUSCH transmissions with or without repetitions in part of the slots of the PUCCH transmission in the time domain. That is, in some slots of the PUCCH transmission, the PUCCH transmission does not overlap with any PUSCH transmission in the time domain. In other slots of the PUCCH transmission, the PUCCH transmission overlaps with the PUSCH transmission in the time domain. In this way, in the slots where the PUCCH transmission overlaps with the PUSCH transmission, the UCI in the PUCCH transmission is multiplexed in the PUSCH transmission overlapping with the PUCCH transmission, and the PUCCH transmission is not transmitted. In the slots where the PUCCH transmission does not overlap with any PUSCH transmission, the PUCCH transmission is still transmitted. So, the UCI in the PUCCH transmission has two transmission modes, one is through PUCCH transmission, and the other is through PUSCH transmission.

In some implementations, for better joint decoding between the two transmission modes, at least one of the following conditions is required for the PUCCH transmission and the PUSCH transmission: the UCI information in the PUCCH transmission exceeds 2 bits, the PUCCH transmission and the PUSCH transmission use the same modulation, the UCI information in the PUCCH transmission is a single UCI type (for example, one of HARQ-ACK, CSI-1 and CSI-2), and/or the resource size used by the UCI in PUCCH transmission is the same as that used by the UCI in PUSCH transmission.

In some implementations, for better joint decoding between the two transmission modes, all of the following conditions is required for the PUCCH transmission and the PUSCH transmission: the UCI information in the PUCCH transmission exceeds 2 bits, the PUCCH transmission and the PUSCH transmission use the same modulation, the UCI information in the PUCCH transmission is a single UCI type (for example, one of HARQ-ACK, CSI-1 and CSI-2).

In some implementations, for better joint decoding between the two transmission modes, all of the following conditions is required for the PUCCH transmission and the PUSCH transmission: the UCI information in the PUCCH transmission exceeds 2 bits, the PUCCH transmission and the PUSCH transmission use the same modulation, the UCI information in the PUCCH transmission is a single UCI type (for example, one of HARQ-ACK, CSI-1 and CSI-2), and the resource size used by the UCI in PUCCH transmission is the same as that used by the UCI in PUSCH transmission.

In some implementations, when the PUSCH transmission are multiple, the multiple PUSCH transmissions are required to meet at least one of the following requirements: they have the same UL DAI value, they have the same modulation, and/or they have the same beta-offset for same UCI type.

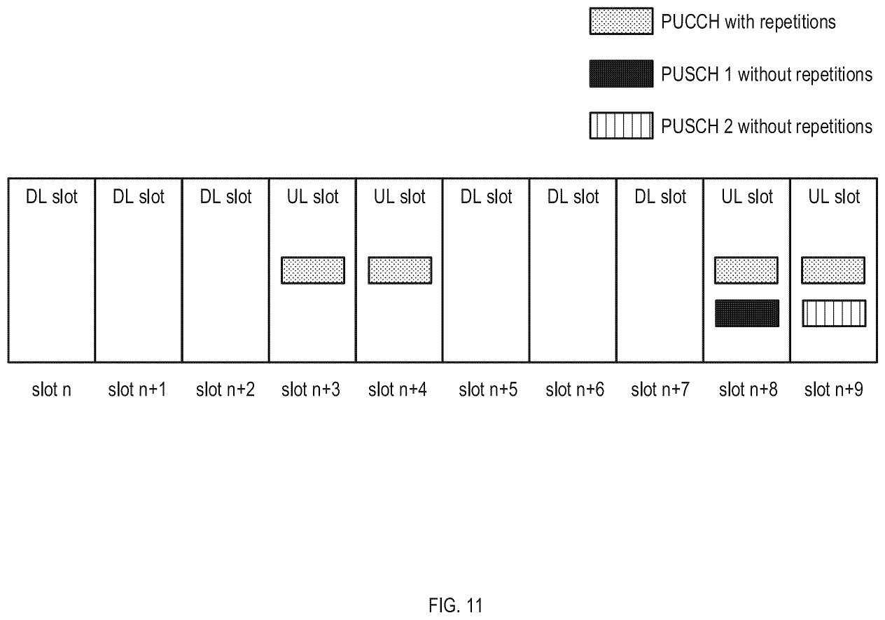

For a non-limiting example as shown in FIG. 11, a PUCCH transmission with a repetition factor of 4 starts in slot n+3, and the remaining repetitions are in slot n+4, slot n+8, and slot n+9. A PUSCH1 transmission without repetition factor is transmitted in slot n+8. A PUSCH2 transmission without repetition factor is transmitted in slot n+9.

In some implementations, the UCI information in the PUCCH transmission is HARQ-ACK greater than 2 bits. The PUCCH transmission, the PUSCH1 transmission and the PUSCH2 transmission have the same modulation. The PUSCH1 transmission and PUSCH2 transmission are configured with the same UL DAI value and beta-offset value. In the slot n+8 of the PUCCH transmission, the repetition of the PUCCH transmission overlaps with the PUSCH1 transmission in the time domain. In slot n+9 of the PUCCH transmission, the repetition of the PUCCH transmission overlaps with the PUSCH2 transmission in the time domain. In slot n+3 and slot n+4 of the PUCCH transmission, the PUCCH transmission does not overlap with any PUSCH in the time domain. That is, in a portion of the slots of the PUCCH transmission with a repetition factor, the PUCCH repetition overlaps with the PUSCH transmission in the time domain.

In some implementations, the detailed operation may include: the PUCCH transmission is transmitted in slot n+3 and slot n+4. In slot n+8, the HARQ-ACK in the PUCCH transmission is multiplexed on the PUSCH1 transmission. In slot n+9, the HARQ-ACK in the PUCCH transmission is multiplexed in the PUSCH2 transmission. The PUCCH transmission is no longer transmitted in slot n+8 and slot n+9.

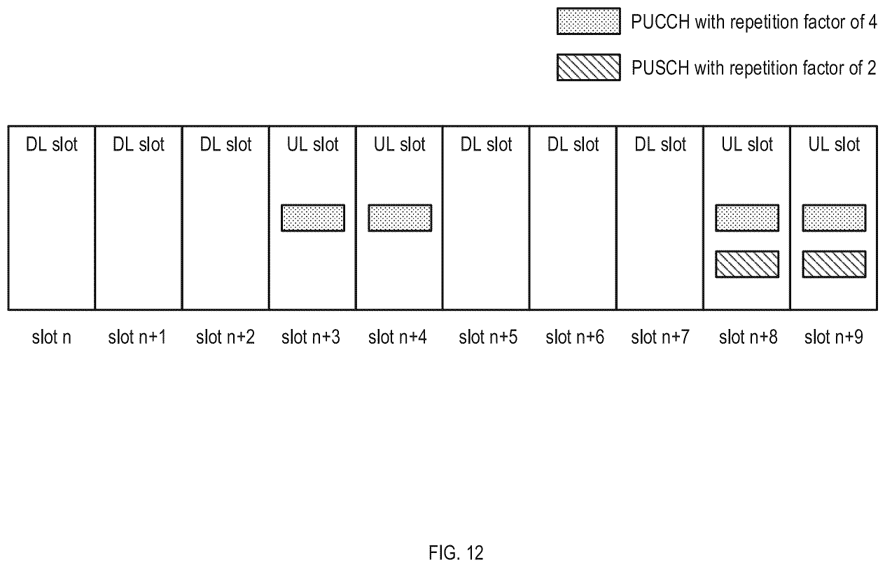

For another non-limiting example as shown in FIG. 12, a PUCCH transmission with a repetition factor of 4 starts in slot n+3, and the remaining repetitions are in slot n+4, slot n+8, and slot n+9. A PUSCH transmission with a repetition factor of 2 is transmitted in slot n+8 and slot n+9.

In some implementations, the UCI information in the PUCCH transmission is HARQ-ACK greater than 2 bits. The PUCCH transmission and the PUSCH transmission have the same modulation. In the slot n+8 of the PUCCH transmission, the repetition of the PUCCH transmission overlaps with the PUSCH transmission in the time domain. In slot n+9 of the PUCCH transmission, the repetition of the PUCCH transmission overlaps with the PUSCH transmission in the time domain. In slot n+3 and slot n+4 of the PUCCH transmission, the PUCCH transmission does not overlap with any PUSCH in the time domain. That is, in a portion of the slots of the PUCCH transmission with a repetition factor, the PUCCH repetition overlaps with the PUSCH transmission in the time domain.

In some implementations, the detailed operation is: the PUCCH transmission is transmitted in slot n+3 and slot n+4. In slot n+8, the HARQ-ACK in the PUCCH transmission is multiplexed on the PUSCH transmission. In slot n+9, the HARQ-ACK in the PUCCH transmission is multiplexed in the PUSCH transmission. The PUCCH transmission is no longer transmitted in slot n+8 and slot n+9.

For the examples as shown in FIGS. 11 and 12, in slot n+8 and slot n+9, the HARQ-ACK in the PUCCH transmission is multiplexed in the PUCCH transmission, and both the HARQ-ACK and the PUSCH transmission are finally transmitted. When the existing technology is used, the PUSCH transmission is dropped, and only the HARQ-ACK is transmitted in the PUCCH transmission.

In various embodiments, for the specific case that PUCCH transmission and PUSCH transmission overlap in time domain, the conditions for executing UCI multiplexing are provided. When these conditions are met, the corresponding UCI multiplexing is executed, and UCIs transmitted based on PUCCH mode and PUSCH mode may still be jointly decoded. The specific case may include that the partial repetitions of a PUCCH transmission with repetitions overlap with one or more PUSCH transmissions with or without repetition factors in the time domain in the one or more slots, and the remaining repetitions of the PUCCH transmission do not overlap with any PUSCH transmission in the time domain in the other one or more slots. The given conditions may include that the PUCCH transmission has the same modulation as the PUSCH transmission. The UCI in the PUCCH transmission is a single UCI type with more than 2 bits. When the PUSCH transmissions are multiple, the multiple PUSCH transmissions have the same modulation (and the same beta-offset).

The present disclosure describes methods, apparatus, and computer-readable medium for wireless communication. The present disclosure addressed the issues with uplink control information (UCI) multiplexing for physical uplink shared channel (PUSCH) and physical uplink control channel (PUCCH) with repetitions. The methods, devices, and computer-readable medium described in the present disclosure may facilitate the performance of wireless communication by configuring and scheduling UCI multiplexing, thus improving efficiency and overall performance. The methods, devices, and computer-readable medium described in the present disclosure may improve the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
executing, by a user equipment (UE), uplink control information (UCI) multiplexing for at least one physical uplink shared channel (PUSCH) transmission and a physical uplink control channel (PUCCH) transmission with repetitions, by:
determining, by the UE, that at least one PUCCH repetition of the PUCCH transmission with repetitions overlaps with the at least one PUSCH transmission in a time domain;
multiplexing, by the UE, UCI in the at least one PUCCH repetition on the at least one PUSCH transmission; and
transmitting, by the UE, the UCI multiplexing on the at least one PUSCH transmission to a base station.

2. A method for wireless communication, comprising:
configuring, by a base station to a user equipment (UE), at least one physical uplink shared channel (PUSCH) transmission and a physical uplink control channel (PUCCH) transmission with repetitions, wherein the at least one PUCCH repetition of the PUCCH transmission with repetitions overlaps with the at least one PUSCH transmission in a time domain; and
receiving, by the base station from the UE, UCI multiplexing on the at least one PUSCH transmission.

3. The method according to claim 1, wherein:
each PUCCH repetition of the PUCCH transmission with repetitions in each corresponding slot overlaps with a PUSCH transmission in the time domain; and
the multiplexing the UCI in the at least one PUCCH repetition on the at least one PUSCH transmission and transmitting the UCI multiplexing on the at least one PUSCH transmission to the base station comprises: in response to determining a condition being satisfied, multiplexing, by the UE, UCI in the PUCCH repetition on the PUSCH transmission in the each corresponding slot and transmitting the UCI multiplexing on the PUSCH transmission without transmitting the PUCCH repetition in the each corresponding slot to the base station.

4. The method according to claim 1, wherein:
each PUCCH repetition of the PUCCH transmission with repetitions in each corresponding slot overlaps with a PUSCH repetition of a PUSCH transmission with repetitions in the time domain; and
the multiplexing the UCI in the at least one PUCCH repetition on the at least one PUSCH transmission and transmitting the UCI multiplexing on the at least one PUSCH transmission to the base station comprises: multiplexing, by the UE, UCI in the PUCCH repetition on the PUSCH repetition in the each corresponding slot and transmitting the UCI multiplexing on the PUSCH repetition without transmitting the PUCCH repetition in the each corresponding slot to the base station,
wherein: the PUCCH transmission with repetitions and the PUSCH transmission with repetitions are located in same slots.

5. The method according to claim 1, wherein:
each PUCCH repetition of the PUCCH transmission with repetitions in each corresponding slot overlaps with more than one PUSCH transmissions in the time domain, the more than one PUSCH transmissions comprises at least one of a PUSCH repetition of a PUSCH transmission with repetitions or a PUSCH transmission without repetitions; and
the multiplexing the UCI in the at least one PUCCH repetition on the at least one PUSCH transmission and transmitting the UCI multiplexing on the at least one PUSCH transmission to the base station comprises:
for a first slot where a first PUCCH repetition is located, multiplexing, by the UE, UCI in the first PUCCH repetition on a first PUSCH transmission in the first slot and transmitting the UCI multiplexing on the first PUSCH transmission without transmitting the first PUCCH repetition in the first slot to the base station, wherein:
the first PUSCH transmission is a first PUSCH repetition of a first PUSCH transmission with repetitions,
the first PUSCH transmission has an earliest start symbol among the more than one PUSCH transmission in the first slot, and
PUCCH slots where the PUCCH repetitions of the PUCCH transmission with repetitions are located are a subset of PUSCH slots where the PUSCH repetitions of the first PUSCH transmission with repetitions are located; and
for a slot where a PUCCH repetition, other than the first repetition, is located, multiplexing, by the UE, UCI in the PUCCH repetition on a PUSCH repetition, other than the first PUSCH repetition, of the first PUSCH transmission with repetitions in the slot and transmitting the UCI multiplexing on the PUSCH repetition without transmitting the PUCCH repetition in the first slot to the base station.

6. The method according to claim 1, wherein:
each PUCCH repetition of the PUCCH transmission with repetitions in each corresponding slot overlaps with a PUSCH repetition of a PUSCH transmission with repetitions in the time domain; and
the multiplexing the UCI in the at least one PUCCH repetition on the at least one PUSCH transmission and transmitting the UCI multiplexing on the at least one PUSCH transmission to the base station comprises: multiplexing, by the UE, UCI in the PUCCH repetition on the PUSCH repetition of the PUSCH transmission with repetitions in the each corresponding slot and transmitting the UCI multiplexing on the PUSCH repetition of the PUSCH transmission with repetitions without transmitting the PUCCH repetition in the each corresponding slot to the base station.

7. The method according to claim 6, wherein:
the PUCCH transmission with repetitions and the PUSCH transmission with repetitions have a same starting slot;
PUCCH slots where the PUCCH repetitions of the PUCCH transmission with repetitions are located are a subset of PUSCH slots where the PUSCH repetitions of a first PUSCH transmission with repetitions are located; and
the multiplexing the UCI in the at least one PUCCH repetition on the at least one PUSCH transmission and transmitting the UCI multiplexing on the at least one PUSCH transmission to the base station comprises: for at least one remaining PUSCH repetition of the PUSCH transmission that does not overlap with any PUCCH transmission:
multiplexing, by the UE, UCI in the PUCCH repetition on the at least one remaining PUSCH repetition and transmitting the UCI multiplexing on the at least one remaining PUSCH repetition to the base station, or
directly transmitting, by the UE, the at least one remaining PUSCH repetition without transmitting the UCI multiplexing on the at least one remaining PUSCH repetition to the base station.

8. The method according to claim 6, wherein:
the PUCCH transmission with repetitions and the PUSCH transmission with repetitions have different starting slots;
PUCCH slots where the PUCCH repetitions of the PUCCH transmission with repetitions are located are a subset of PUSCH slots where the PUSCH repetitions of a first PUSCH transmission with repetitions are located; and
the multiplexing the UCI in the at least one PUCCH repetition on the at least one PUSCH transmission and transmitting the UCI multiplexing on the at least one PUSCH transmission to the base station comprises: for at least one remaining PUSCH repetition of the PUSCH transmission that does not overlap with any PUCCH transmission:
multiplexing, by the UE, UCI in the PUCCH repetition on the at least one remaining PUSCH repetition and transmitting the UCI multiplexing on the at least one remaining PUSCH repetition to the base station, or
directly transmitting, by the UE, the at least one remaining PUSCH repetition without transmitting the UCI multiplexing on the at least one remaining PUSCH repetition to the base station.

9. The method according to claim 1, wherein:
each PUCCH repetition of multiple PUCCH transmissions with repetitions in each corresponding slot overlaps with a PUSCH repetition of a PUSCH transmission with repetitions in the time domain; and
the multiplexing the UCI in the at least one PUCCH repetition on the at least one PUSCH transmission and transmitting the UCI multiplexing on the at least one PUSCH transmission to the base station comprises: multiplexing, by the UE, each UCI in the PUCCH repetition of the multiple PUCCH transmissions with repetitions on the overlapping PUSCH repetition in the each corresponding slot and transmitting the UCI multiplexing on the overlapping PUSCH repetition without transmitting the PUCCH repetition in the each corresponding slot to the base station.

10. The method according to claim 1, wherein:
each PUCCH repetition of multiple PUCCH transmissions with repetitions in each corresponding slot overlaps with a PUSCH repetition of a PUSCH transmission with repetitions in the time domain; and
the multiplexing the UCI in the at least one PUCCH repetition on the at least one PUSCH transmission and transmitting the UCI multiplexing on the at least one PUSCH transmission to the base station comprises:
for slots where PUCCH repetitions of a first PUCCH transmission with repetitions having earliest starting slot are located, multiplexing, by the UE, each UCI in the PUCCH repetitions of the first PUCCH transmission with repetitions on the overlapping PUSCH repetition in the each corresponding slot and transmitting the UCI multiplexing on the overlapping PUSCH repetition without transmitting the PUCCH repetition to the base station; and
for other slots where PUCCH repetitions, other than the first PUCCH transmission with repetitions having earliest starting slot, are located, directly transmitting, by the UE, the overlapping PUSCH repetition without the UCI multiplexing in each corresponding slot to the base station.

11. The method according to claim 1, wherein:
each PUCCH repetition of the PUCCH transmission with repetitions in each corresponding slot overlaps with a PUSCH transmission of multiple PUSCH transmissions in the time domain, the multiple PUSCH transmissions comprises at least one of a PUSCH transmission with repetitions or a PUSCH transmission without repetitions; and
the multiplexing the UCI in the at least one PUCCH repetition on the at least one PUSCH transmission and transmitting the UCI multiplexing on the at least one PUSCH transmission to the base station comprises: in response to determining a condition being satisfied, multiplexing, by the UE, UCI in the PUCCH repetition on each overlapping PUSCH transmission in the each corresponding slot and transmitting the UCI multiplexing on the PUSCH transmission without transmitting the PUCCH repetition in the each corresponding slot to the base station.

12. The method according to claim 11, wherein:
the condition comprises at least one of the following:
the multiple PUSCH transmissions having a same modulation mode,
the multiple PUSCH transmissions having a same uplink (UL) downlink assignment index (DAI), or
the multiple PUSCH transmissions having a same beta-offset.

13. The method according to claim 11, wherein:
the multiple PUSCH transmissions comprise a plurality of PUSCH transmissions with repetitions.

14. The method according to claim 11, wherein:
the multiple PUSCH transmissions comprise at least one PUSCH transmission and at least one PUSCH transmission without repetitions.

15. The method according to claim 1, wherein:
each PUCCH repetition of a portion of the PUCCH transmission with repetitions in each corresponding slot overlaps with a PUSCH transmission of multiple PUSCH transmissions in the time domain, the multiple PUSCH transmissions comprises at least one of a PUSCH transmission with repetitions or a PUSCH transmission without repetitions; and
the multiplexing the UCI in the at least one PUCCH repetition on the at least one PUSCH transmission and transmitting the UCI multiplexing on the at least one PUSCH transmission to the base station comprises: in response to determining a condition being satisfied:
for slots where PUCCH repetitions overlapping the PUSCH transmissions are located, multiplexing, by the UE, each UCI in the PUCCH repetitions overlapping the PUSCH transmissions on the overlapping PUSCH repetition in the each corresponding slot and transmitting the UCI multiplexing on the overlapping PUSCH repetition without transmitting the PUCCH repetition to the base station, and
for other slots where PUCCH repetitions without any overlapping PUSCH transmission are located, directly transmitting, by the UE, the PUSCH repetitions without any overlapping PUSCH transmission in each corresponding slot to the base station.

16-20. (canceled)

21. An apparatus comprising:
a memory storing instructions; and
at least one processor in communication with the memory, wherein, when the at least one processor executes the instructions, the at least one processor is configured to cause the apparatus to execute uplink control information (UCI) multiplexing for at least one physical uplink shared channel (PUSCH) transmission and a physical uplink control channel (PUCCH) transmission with repetitions, by:
determining that at least one PUCCH repetition of the PUCCH transmission with repetitions overlaps with the at least one PUSCH transmission in a time domain;
multiplexing UCI in the at least one PUCCH repetition on the at least one PUSCH transmission; and
transmitting the UCI multiplexing on the at least one PUSCH transmission to a base station.

22. The apparatus according to claim 21, wherein:
each PUCCH repetition of the PUCCH transmission with repetitions in each corresponding slot overlaps with a PUSCH transmission in the time domain; and
when the at least one processor is configured to cause the apparatus to perform multiplexing the UCI in the at least one PUCCH repetition on the at least one PUSCH transmission and transmitting the UCI multiplexing on the at least one PUSCH transmission to the base station, the at least one processor is configured to cause the apparatus to perform: in response to determining a condition being satisfied, multiplexing UCI in the PUCCH repetition on the PUSCH transmission in the each corresponding slot and transmitting the UCI multiplexing on the PUSCH transmission without transmitting the PUCCH repetition in the each corresponding slot to the base station.

23. The apparatus according to claim 21, wherein:
each PUCCH repetition of the PUCCH transmission with repetitions in each corresponding slot overlaps with a PUSCH repetition of a PUSCH transmission with repetitions in the time domain; and
when the at least one processor is configured to cause the apparatus to perform multiplexing the UCI in the at least one PUCCH repetition on the at least one PUSCH transmission and transmitting the UCI multiplexing on the at least one PUSCH transmission to the base station, the at least one processor is configured to cause the apparatus to perform: multiplexing UCI in the PUCCH repetition on the PUSCH repetition in the each corresponding slot and transmitting the UCI multiplexing on the PUSCH repetition without transmitting the PUCCH repetition in the each corresponding slot to the base station,
wherein: the PUCCH transmission with repetitions and the PUSCH transmission with repetitions are located in same slots.

24. The method according to claim 2, wherein:
each PUCCH repetition of the PUCCH transmission with repetitions in each corresponding slot overlaps with a PUSCH transmission in the time domain; and
in response to a condition being satisfied, UCI in the PUCCH repetition is multiplexed on the PUSCH transmission in the each corresponding slot and the UCI multiplexing on the PUSCH transmission is transmitted without transmitting the PUCCH repetition in the each corresponding slot to the base station.

25. The method according to claim 2, wherein:
each PUCCH repetition of the PUCCH transmission with repetitions in each corresponding slot overlaps with a PUSCH repetition of a PUSCH transmission with repetitions in the time domain; and
UCI in the PUCCH repetition is multiplexed on the PUSCH repetition in the each corresponding slot and the UCI multiplexing on the PUSCH repetition is transmitted without transmitting the PUCCH repetition in the each corresponding slot to the base station,
wherein: the PUCCH transmission with repetitions and the PUSCH transmission with repetitions are located in same slots.
